(19) United States
(12) Patent Application Publication
(10) Pub. No.: US 2013/0234582 A1
(43) Pub. Date: Sep. 12, 2013

(54) FIELD EMISSION APPARATUS AND HAND-HELD NONDESTRUCTIVE INSPECTION APPARATUS

(71) Applicants: Yoshihisa Ishiguro, Tokyo (JP); Masanori Haba, Tokyo (JP)

(72) Inventors: Yoshihisa Ishiguro, Tokyo (JP); Masanori Haba, Tokyo (JP)

(73) Assignee: MICRO-X JAPAN LTD., Tokyo (JP)

(21) Appl. No.: 13/883,991

(22) PCT Filed: Jun. 8, 2011
(86) PCT No.: PCT/JP2011/003242

§ 371 Date: May 7, 2013

(30) Foreign Application Priority Data
Nov. 8, 2010 (JP) JP 2010-250087
Jun. 8, 2011 (JP) PCT/JP2011/003242

(51) Int. Cl. H01J 19/54; H01J 19/42

(52) U.S. Cl. CPC H01J 19/54; H01J 19/42
USPC 313/293; 313/310

(57) ABSTRACT

In the present invention, heat dissipation is improved by extending the creepage distance in a vacuum vessel according to the size of a flange portion, without lengthening the vacuum vessel in the direction in which an electron beam is emitted.

A vacuum vessel (20) in which a flange portion (20a) having a hollow portion between a cold cathode (9) and an anode (11) is formed is used.

One example is a vacuum vessel (20) in which a cold cathode vessel (21) and an anode vessel (22), both cylindrically shaped, are communicated with each other and a hollow flange portion (20a) is formed between the vessels (21, 22).

A focusing electrode (14) and a getter material (15), for example, are disposed in the hollow portion of the flange portion (20a).

A cold cathode (9) which has a guard electrode on the outer side of the periphery of a carbon film structure (10) formed on a substrate (7) may be used. The carbon film structure (10) may be formed in the middle of an electrode surface of the substrate (7).

### TECHNICAL FIELD

This invention relates to a field emission device and a portable non-destructive inspection device having electron emitters and being applicable to various kinds of electron tubes, lighting device, X-ray devices, etc.

### BACKGROUND ART

Field emission is a phenomenon whereby electrons are emitted into a vacuum by the concentration of an electric field, and as an emitter for this type of field emission the carbon nano-tube, for example, is attracting attention. A carbon nano-tube has favorable field emission properties owing to its extreme thinness and high aspect ratio and is said to be beneficial in obtaining field emission electron elements. There have been attempts to apply it as a field emission device for electron tubes, lighting device, etc.

Field emission property (‘I-V characteristics’) means a property described by a curve that shows the relationship between voltage (V) and emission current (I) when voltage (V) is applied between the anode (target) and the cold cathode, and is characterized by the voltage when the field emission commences (threshold voltage) as well as by the slope and shape of the curve.

An example of a field emission device is a cold cathode luminescent lamp, which has an anode with a luminescent body positioned to be facing the cold cathode, and voltage is applied between the cold cathode and anode (anode-cathode voltage) in order to have an electron beam emitted from the cold cathode which is accelerated before hitting and elating the luminescent body to produce light. For the production of light by the luminescent body, a certain quantity of electron emission is required. The I-V characteristic curve, with the emission current that shows the quantity of electron emission as the vertical axis and the anode-cathode voltage as the horizontal axis, shows the electron emission efficiency of the cold cathode. In case of carbon nano-tubes, the slope of the I-V Property rises moderately. For this reason, in the case of carbon nano-tubes, the voltage V required to obtain an emission current that triggers the production of light by the luminescent body is high.

However, the fact that the value of the applied voltage V for obtaining the required emission current is large also has issues such as the emergence of characteristic change (degradation) of the carbon nano-tube itself, a requirement for a special power supply due to the high voltage required to obtain a certain level of current, and the construction of the cold cathode luminescent lamp. Therefore, there have been expectations for the attainment of carbon films for use as a cold cathode that offer the I-V characteristics whereby a lower voltage V can produce an emission current enabling the luminescent body to emit light.

In recent years, carbon film structures formed by multi-layer graphene sheets with a hollow in the center and with a distribution of cone shape structures have been developed by the inventors of this Invention. These carbon film structures consist of units of carbon films formed on the substrate, and each unit of carbon film structures has a trunk shape carbon film and a number of branch shape carbon films formed to surround the trunk shape from middle to bottom of the trunk shape. The trunk shape carbon film is characterized by multiple layers of graphene sheets with a hollow inside, with the cone shape of which the radius of the cone gets smaller toward the tip of the shape. (for example, patent literatures 1 to 3) By use of an electron emitter consisting of this type of carbon film structure, owing to the cone shape of which the radius reduces to a pin size toward the tip, it is possible to obtain the required emission current at a lower applied voltage compared to carbon nano-tubes, thus enabling a field emission device with superior I-V characteristics to be offered.

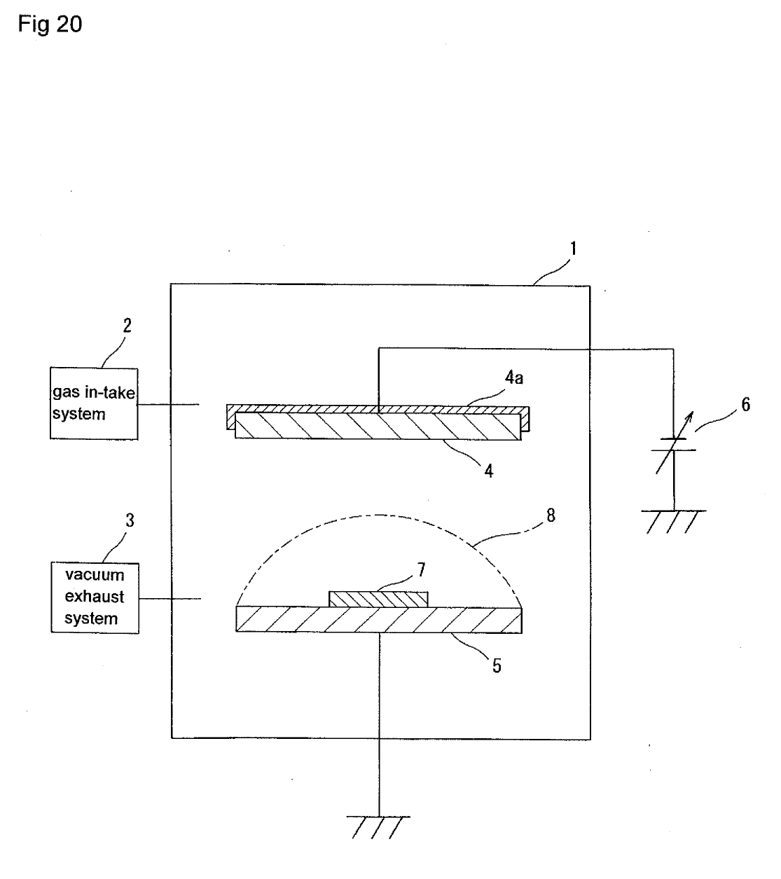

FIG. 20 is a skeleton drawing of film forming equipment of plasma CVD method (direct current plasma deposition method), as an example of creating the carbon film structures. As shown in FIG. 20, vacuum deposition chamber 1 is equipped with a gas intake system 2 (for example, an intake system of a mixture of hydrogen gas and a gas that contains carbon, such as methane gas) and vacuum exhaust system 3, and within the vacuum deposition chamber 1 the cathode 4 (an electrode equipped with insulating cooling panel 4a and the anode 5 are positioned to face each other. Mark 6 shows DC power supply, and the negative pole of this DC power supply 6 is connected with the cathode 4. The positive pole and the anode 5 are both grounded.

With this film forming equipment, firstly the deposition chamber 1 is evacuated by the vacuum exhaust system 3 and draws gas (hydrogen gas) from the gas intake system 2 under gradual control of the pressure (for example, around 30 torr), and the current is maintained at the required level (for example, around 2.5 A) in order to eliminate oxides on the surface of substrate 7. Secondly, the mixture of gases is drawn from the gas intake system 2 into the deposition chamber 1 to gradually increase the chamber's internal pressure and maintain it (for example, at around 75 torr), while the current from the DC power supply 6 is also gradually increased and maintained (for example, at around 6 A).

By this process, the plasma 8 generated on the substrate 7 brings the temperature of the substrate to the required temperature (for example, between 900 C. degrees and 1150 C. degrees), the carbon containing gas among the mixture of gases breaks down, resulting in the formation of carbon film structures on the surface of the substrate 7. Where appropriate, a mask (schematic omitted) may well be used for the substrate 7 in forming carbon film structures.

When applying an electron emitter having the carbon film structures formed as to the cathode of a field emission device, as shown on cold cathode 9 in FIG. 21 for example, the electrode surface (side in the schematic) of the carbon film structure 10 which is on the cold cathode 9 and the electrode surface of the anode 11 (lower side in the schematics) are placed facing each other within a vacuum insulated tube (for example, vacuum vessel made of heat-resistance glass). Further, an electron lens 14 for focusing an electron beam emitted from the cold cathode 9 and a getter material 15 which can adsorb gaseous molecules remaining in the vacuum vessel 13 are placed.

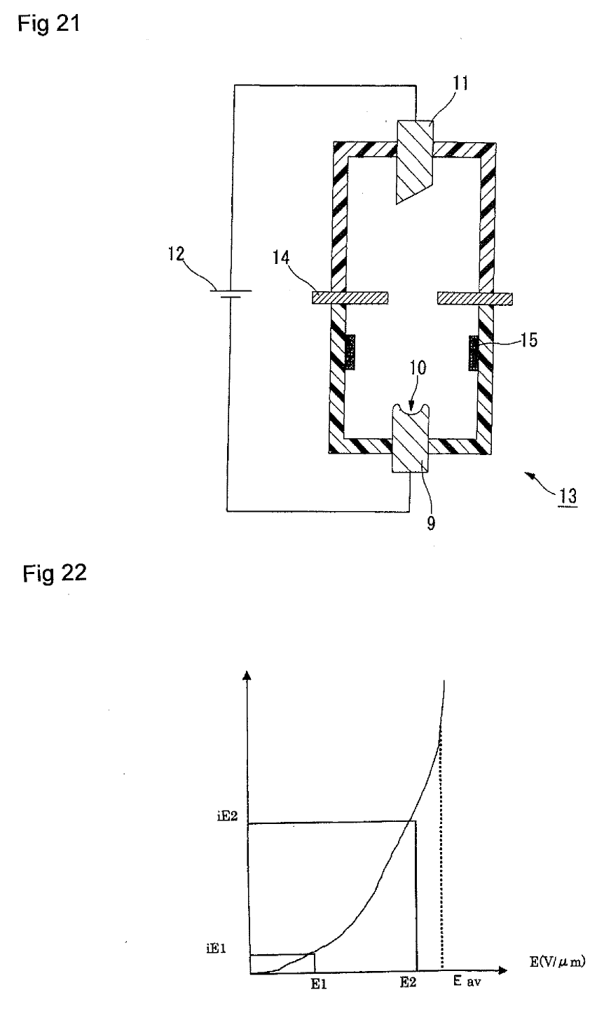

Then, a certain voltage is applied by the DC power supply 12 between the poles, a strong electric field is generated on the carbon film structures 10 (in particular, the tip of the cones) the tunnel electrons shown by the Fowler-Nordheim formula are emitted from the cold cathode 9 toward the anode 11. FIG. 22 shows the electron emission characteristics in this case. It is desirable that the direction of the electron emission (electron beam emitting direction) in this case is at a right angle to the surface of the cold cathode 9.

As aforementioned, for a field emission device having a cold cathode with carbon film structures and with superior I-V characteristics, there is a risk of an electric discharge caused by gases (creeping discharge and flashovers) generated within the vacuum vessel in which the temperature rises significantly (in particular, on the anode side) owing, for example, to electron beams emitted from the cold cathode. For an anode which electron beams hit, temperature of the area bombarded by electron beams (‘electron bean hitting area’) increases by a large quantity of electron beams entering into the anode, resulting in emission of gases as well. A large quantity of electron beams entering into the anode sometimes heats the anode to 500 C. degrees or above, leading to deformation of the anode.

To cope with this, for a field emission device having a vacuum vessel as shown in FIG. 21 for example, there are thoughts for methods to secure sufficient creepage distance as well as enhance exothermic characteristics by enlarging the vacuum vessel's external surface area by using a vacuum vessel whose side wall is materially elongated in the direction of electron beam emission.

However, such a vacuum vessel elongated in the direction of electron beam emission has a longer distance between cold cathode and anode, and aligning them while evacuating calls for a highly specialized vacuum technology, adding further costs to the vacuum vessel itself.

Another idea may be that the anode is elongated in the direction of electron beam emission to shorten the distance between cold cathode and anode, but the longer the length of the anode is in the direction of the electron beam emission (distance between the electron beam hitting area and the outer surface of the vacuum vessel), the lesser the exothermic efficiency becomes, thus leading to difficulties in increasing the capacity of the vacuum vessel (Vxi). This may also lead to a field emission device much larger in size.

An X-ray generation device incorporated into equipment such as non-destructive inspection equipment has a tri-polar structure, having within a single glass vessel a source of electron (emitter), a target and a focusing electrode (grid electrode). The voltage is applied between the emitter and the grid to cause electron emission as well as between the grid and the target to cause the bombardment of those electrons onto the target.

Patent literature 4 discloses the contents of generating linear electron beam by creeping discharge on the surface of an insulated material facing anode, with such an insulating material gripped in the longitudinal direction by the first conductive material and the second, plural number of, conductive materials, by way of grounding the second conductive material through a capacitor or a resistor while a negative polarity high voltage pulse is applied to the first conductive material.

Patent literature 5 discloses a photoionization device with emphasis on versatility which is able to control the dose and energy of soft X-ray individually by way of variably controlling the electron emission voltage applied between the emitter and the grid electrode as well as acceleration voltage applied between the grid electrode and the target.

Patent literature 3 discloses a composition that has an electron emitting layer made of carbon nano-tubes formed on the cathode electrode created on the substrate surface and a gate electrode placed above the electron emitting layer with a conductive layer which is equipotential to the electron emitting layer on the circumference thereof.

### CITATION LIST

### Patent Literature

PTL 1: Patent 2008-150253

PTL 2: Patent 2008-150682

PTL 3: Patent 2010-56062

PTL 4: Patent H05-074394

PTL 5: Patent 2006-066075

PTL 6: Patent 2002-093307

### SUMMARY OF INVENTION

### Technical Problem

As described above, for a field emission device with an electron emitter having carbon film structures, it is understandably necessary, when it is expected to exert a desired function (for example, to use it as a source of electron beam superior in I-V characteristics) to enhance the exothermic efficiency (that of heat caused and generated by electron beams emitted from cold cathode) of a vacuum vessel as well as to secure sufficient creepage distance, in order to maintain the distance between the cold cathode and the anode and the length of the anode in the direction of electron emission.

For an X-ray generation device being one of the field emission devices, an emitter, target and grid have traditionally been housed within a single glass vessel and there have been problems such as fragility, time for manufacture and difficulty in cooling.

### Solution to Problem

This Invention relates to a field emission device capable of solving the problems and consists of primary invention that relates to a field emission device made of two parts, and secondary invention that relates to field emission device made of three parts.

The field emission device relating to the primary invention houses within a vacuum vessel a cold cathode made of electron emitter with carbon film structures grown on the substrate surface and an anode with its electrode surface positioned to face the electrode surface of the cold cathode, and is one that emits an electron beam by way of field emission from the cold cathode when voltage is applied between the cold cathode and the anode, and the vacuum vessel is featured by a part of side wall between cold cathode and anode elongated in the direction that is at right angles to the direction of electron emission and a hollow part, forming a flange.

The vacuum vessel is constructed by attaching the cold cathode side vessel that can house the cold cathode and which has a flange portion to the anode side vessel that can house the anode and which has a flange portion at the flange portion.

The cold cathode side vessel consists of an opening end that is elongated in the direction of the vessel's radius with a circular sealing part that protrudes toward the connection with the anode side vessel, while the anode side vessel consists of an opening end that is elongated in the direction of vessel's radius with a circular sealing part that protrudes toward the connection with the cold cathode side vessel.

The hollow part formed by the flanges may be used to house grid electrode and getter materials. For the carbon film structures, those structures with graphene sheets layer overlapped by a number of pointing ends whose radius decreases toward the tip and that are hollow inside may do as well. It is also good to place a guard electrode, being convex toward the direction of carbon film growth, which is equipotential with the substrate and/or the carbon film structures on the circumference of the carbon film structures, and for the convex surface of the guard electrode it is noted that the radius of curvature of the circumference of the guard electrode is greater than that of the carbon film structure side. Also, it is noted that the peak of the convex surface of the guard electrode protrudes farther toward the carbon film direction than the circumference of carbon film structures. Furthermore, it is noted that the surface of the substrate's side where the carbon film structures are formed is concave.

The carbon film structures may well be formed on the central area of the electrode side of the substrate. In this case, the substrate consists of that which is positioned on the electrode side with a hole bored toward the electron emitting direction and that of carbon film structure supporting substrate which supports the electrode side substrate from the opposite direction of the electrode surface with a protrusion which can be inserted through the hole, and at the tip of the protrusion the carbon film structures are formed.

The field emission device relating to the secondary invention consists of a cold cathode with electron emitter, the target and the grid electrode, and the cold cathode and target are housed each in a separate vessel, and those vessels are connected by the connecting member equipped with the grid electrode.

The cold cathode and target are housed in ceramic vessels and the grid electrode may be incorporated into the metal coupling which connects the ceramic vessels. In order to prevent insulation from being damaged, it is desirable to cover the external surface of the ceramic vessel in molded resin. It is also desirable that the metal connecting member is cylindrical, showing the emitter or the target inside, with the grid electrode incorporated into the edge of the material closer to the emitter.

Portable non-destructive inspection device related to this present Invention has the main body housing the X-ray generation device and the power supply component detachable.

### Advantageous Effects of Invention

As shown above, under the primary invention, it is possible to enhance the exothermic efficiency by extending the creepage distance relative to the dimension of the flange without elongating the vacuum vessel in the direction of the electron emission.

Under the secondary invention, the cold cathode (emitter), target and grid electrode are housed separately or incorporated into the vessel, hence miniaturization of each component is made possible, and as cold cathode and target are housed in a ceramic vessel, insulation damage is less likely and it is therefore unnecessary to dip them in insulation oil, resulting in reduction in both size and weight.

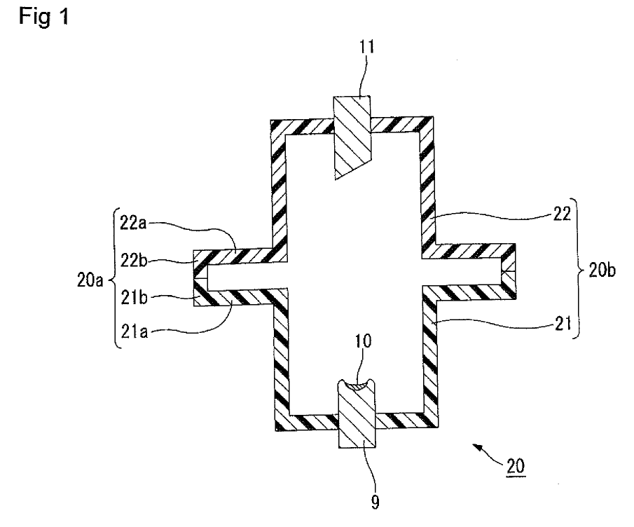

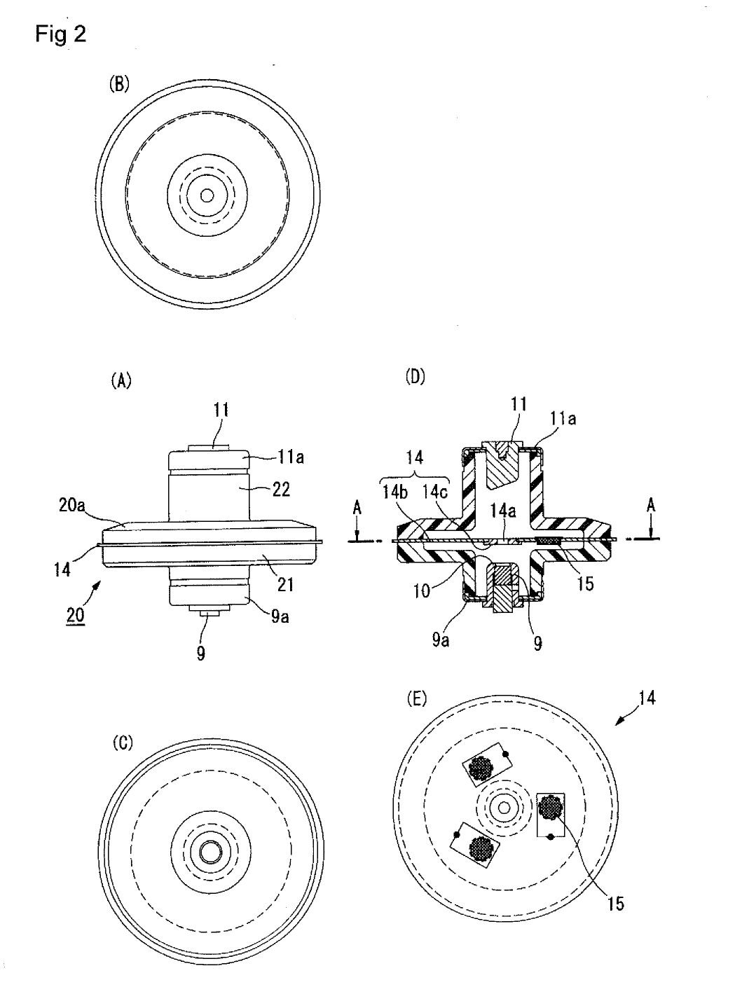

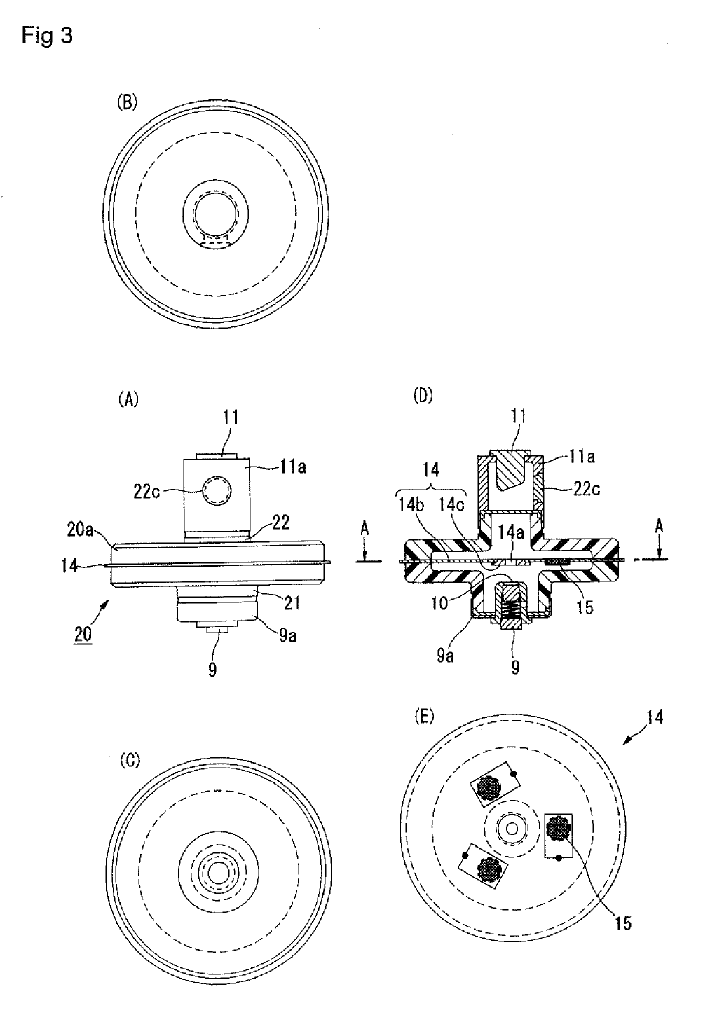

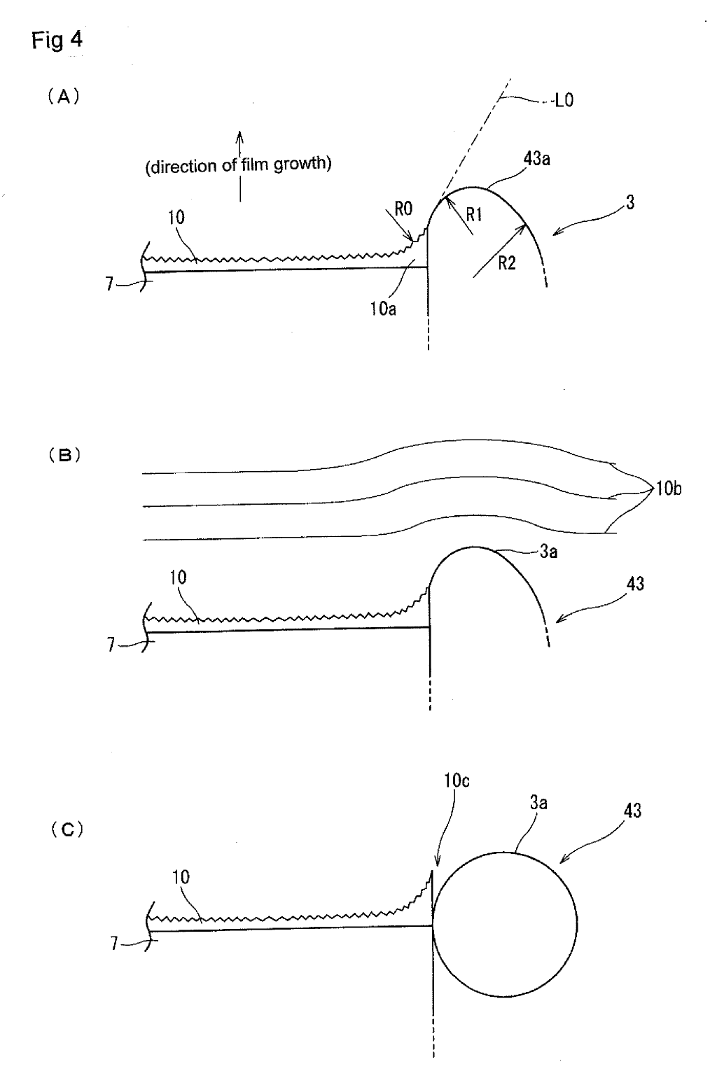

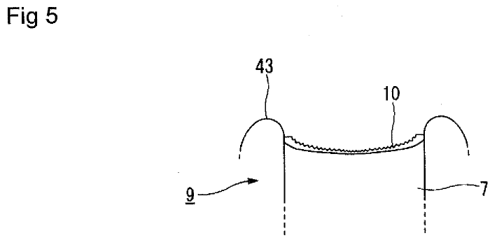

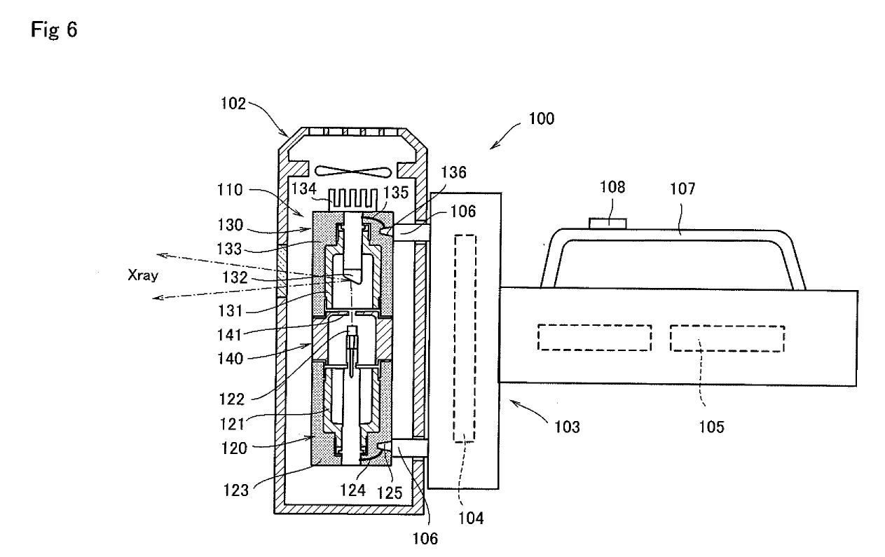

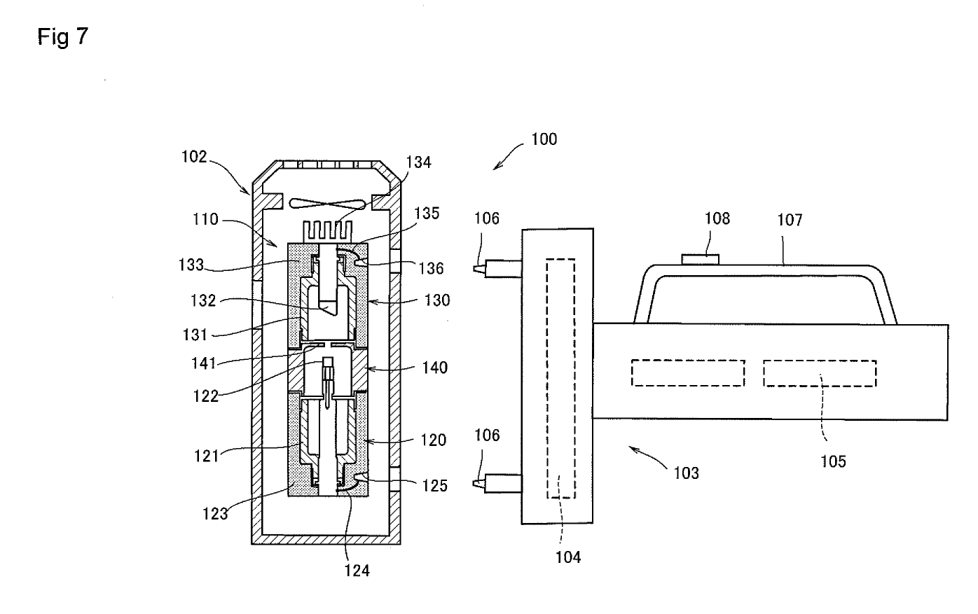

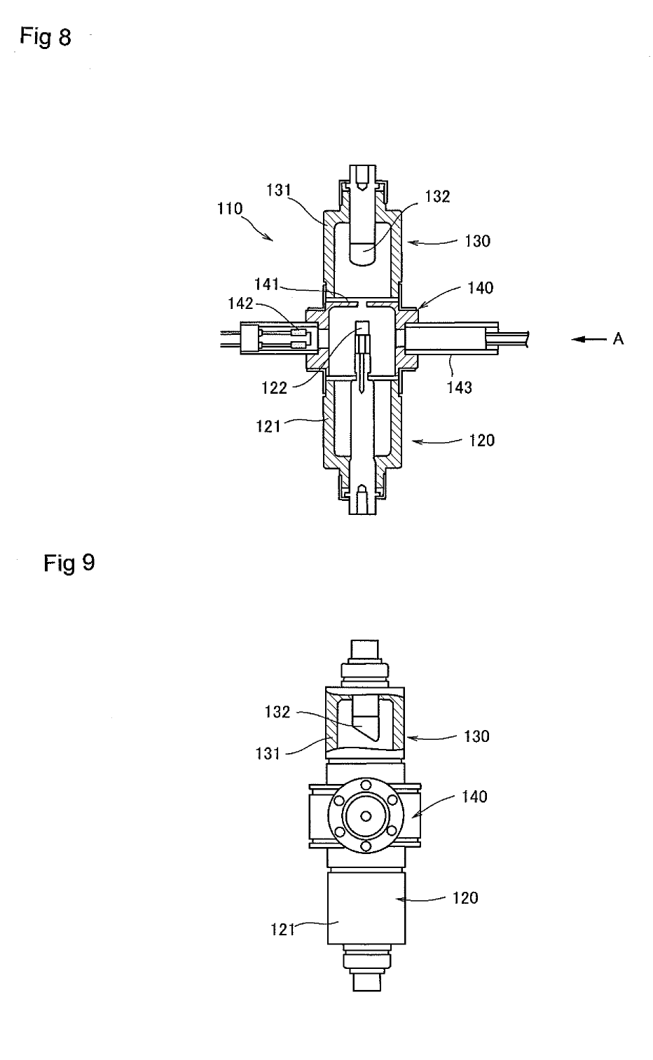

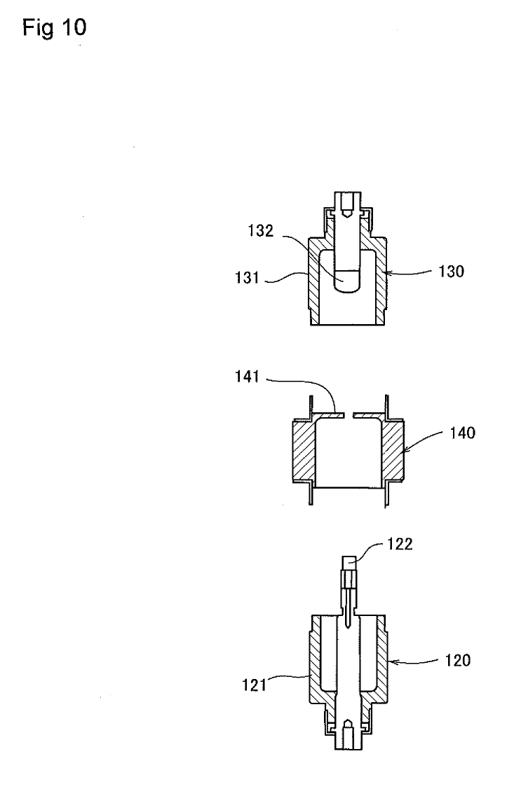

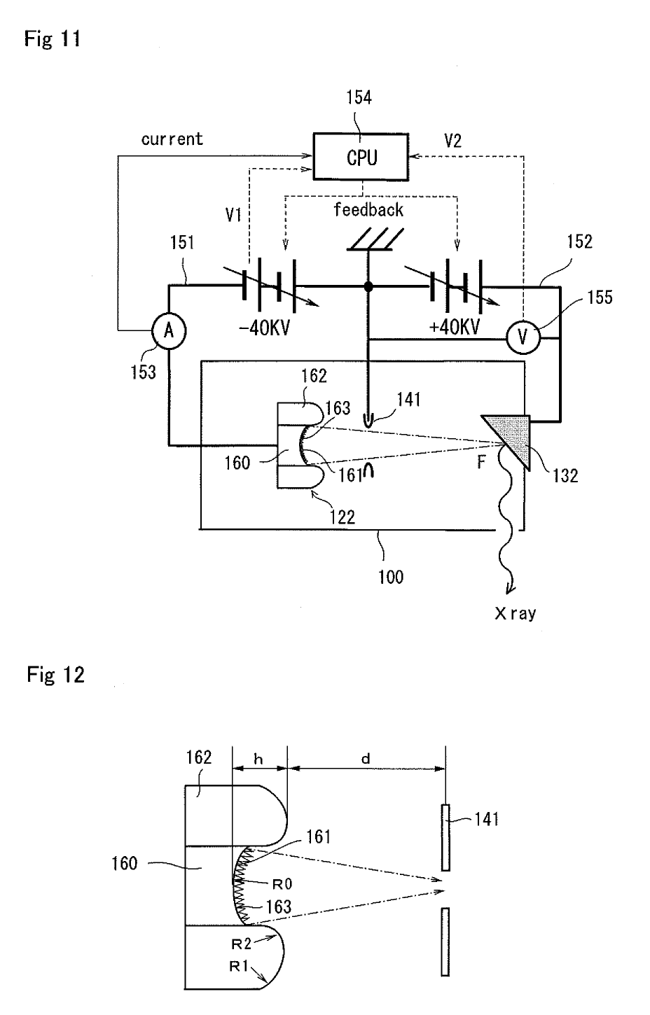

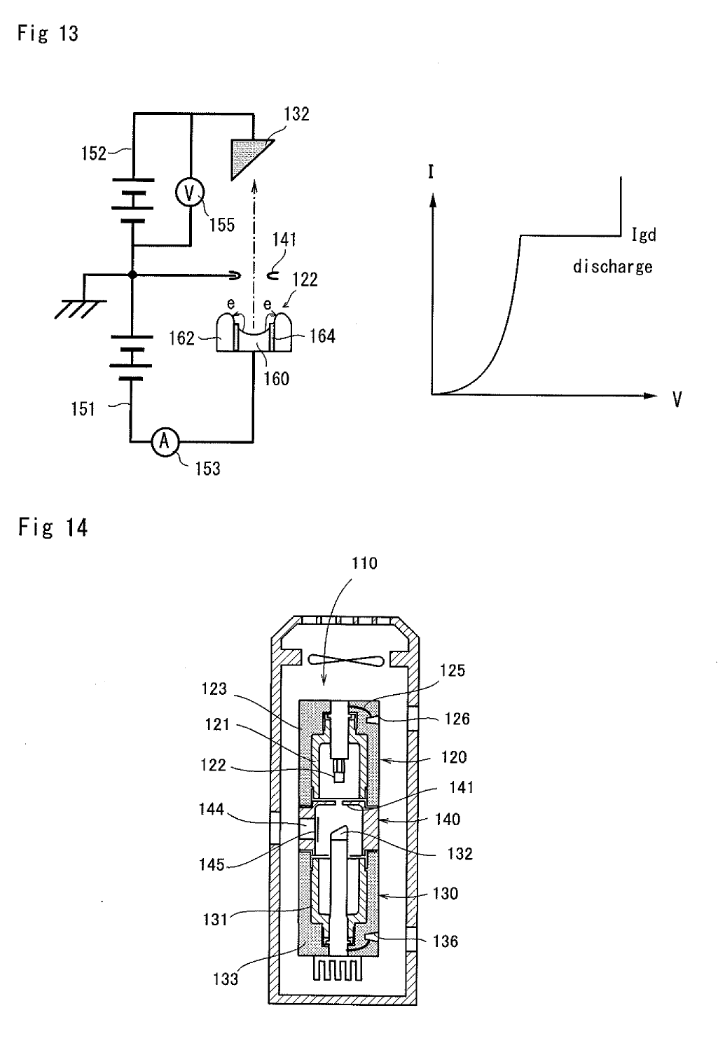

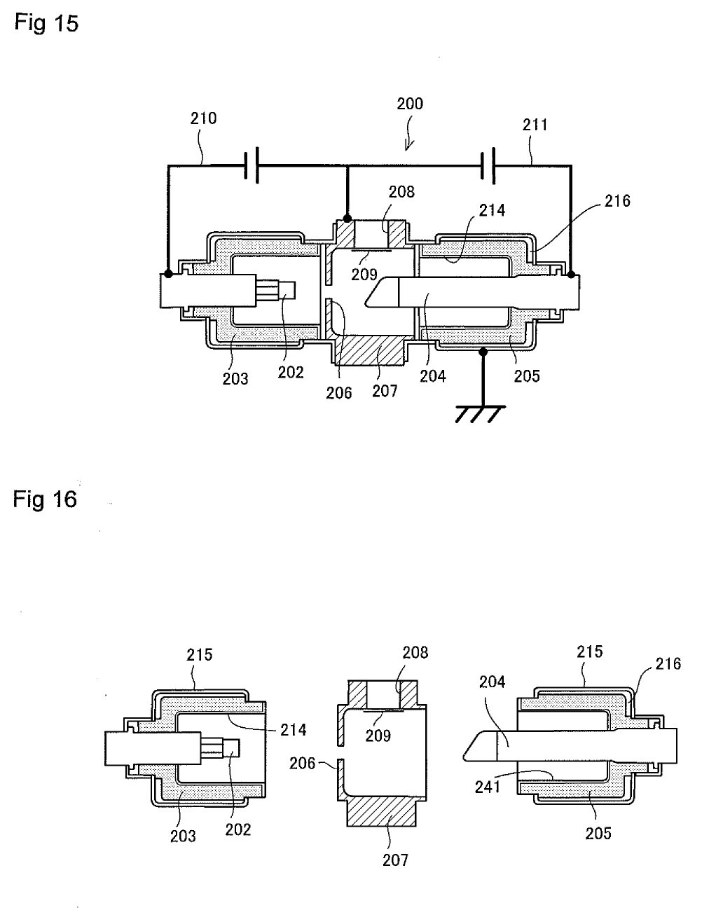

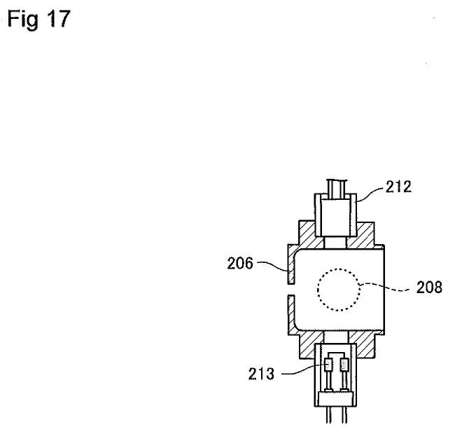

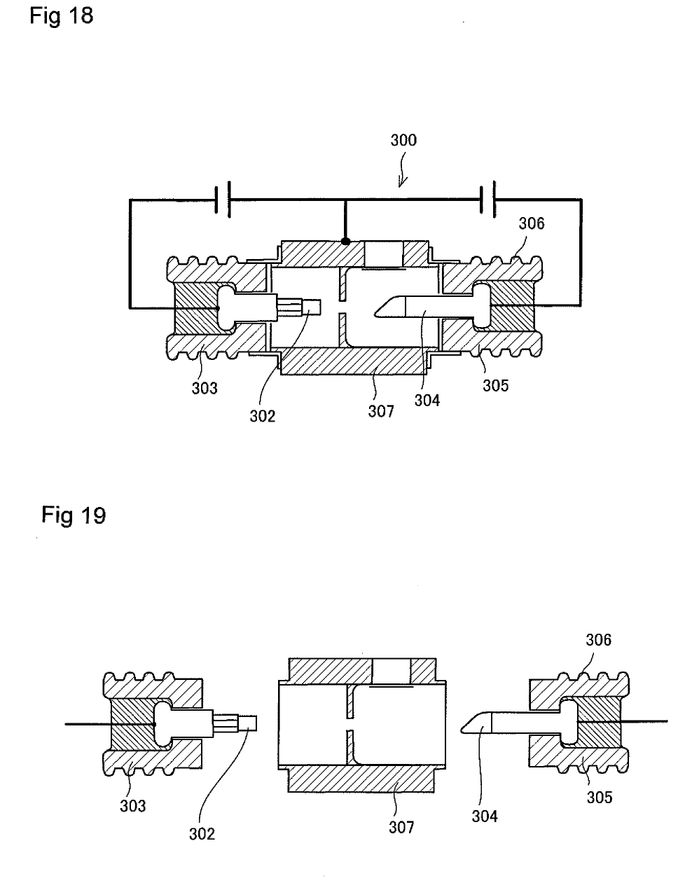

### BRIEF DESCRIPTION OF DRAWINGS

[FIG. 1] Schematic diagram of field emission device of the primary invention

[FIG. 2] Schematic diagram of an example of vacuum vessel for field emission device of the primary invention

[FIG. 3] Schematic diagram of another example of vacuum vessel for field emission device of the primary invention

[FIG. 4] Schematic diagram of an example of cold cathode for field emission device of the primary invention

[FIG. 5] Schematic diagram of another example of vacuum vessel for field emission device of the primary invention

[FIG. 6] Cross section of portable CT device incorporating field emission device (X-ray generation device) relating to the secondary invention

[FIG. 7] Drawing to show the state of separation of main body of a portable non-destructive inspection device and the power supply component

[FIG. 8] Cross section of field emission device (X-ray generation device) relating to the secondary invention

[FIG. 9] Partial section of FIG. 8 seen from the direction A

[FIG. 10] Exploded view of field emission device (X-ray generation device)

[FIG. 11] Schematic configuration of the field emission device (X-ray generation device)

[FIG. 12] Enlarged section of the tip of cold cathode

[FIG. 13] Graph showing I-V curve and another circuit implementation example

[FIG. 14] Diagram showing another implementation example

[FIG. 15] Cross section of field emission device (X-ray generation device) relating to another implementation example

[FIG. 16] Configuration of field emission device (X-ray generation device)

[FIG. 17] Cross section of connecting member incorporating grid electrode seen from direction different to FIG. 16

[FIG. 18] Cross section of field emission device (X-ray generation device) related to another implementation example

[FIG. 19] Configuration of field emission device (X-ray generation device)

[FIG. 20] Schematic diagram to explain plasma CVD method for forming carbon film structures

[FIG. 21] Schematic diagram to explain general field emission device using electron emitter having carbon film structures

[FIG. 22] Graph to show characteristics of electron emission of field emission device

### DESCRIPTION OF EMBODIMENTS

The following are detailed explanations on the implementation mode of the field emission device under the present invention using drawings. Where appropriate, further detailed explanations are omitted for those equivalent to FIG. 20-FIG. 22 and replaced with the same reference signs.

The primary invention is with the elongation of the radius of the vacuum vessel in the direction at right angles to the direction of the electron beam emission at the place between the cold cathode and the anode (for example, the place where grid electrode such as electron lens is positioned) and not with the elongation of the radius of the vacuum vessel in the direction of the electron beam emission as shown in FIG. 21, and by the vacuum vessel having a flange portion with a hollow formed by the elongated side walls, the exothermic efficiency is enhanced without extending the distance between the cold cathode and the anode or elongating the length of the anode in the direction of the electron beam emission while the creepage distance is extended.

In the case of a field emission device to perform desired functions (such as function as source of electron beam superior in I-V characteristics), such measures have generally been taken as simply cooling the vacuum vessel by cooling device or elongating the side walls of the vacuum vessel in the direction of electron beam emission or making the side walls in an accordion shape in order to secure sufficient creepage distance and exothermic efficiency, but there has been no technical thought of having a flange portion with radius-elongated hollow as in the primary invention which not only extends the creepage distance and total area vis-à-vis the external atmosphere in accordance with the size of the flange portion but also shorten the distance at the same time between cold cathode and anode. For example, such field emission device as those using thermal cathode using a filament has not in the past render technical thoughts such as this present invention in the technical field of field emission device because shortening the distance between heated cathode and anode invites thermal influence generated by the filament itself.

The above flange portion only requires a hollow within formed by elongated side walls, and a vacuum vessel whose radius gradually expands from both ends toward the center may do as well.

As for the field emission device under the primary invention, it is possible to adopt vacuum vessel 20 having flange portion 20a as shown in FIG. 1. This vacuum vessel 20 is made by coupling cold cathode side vessel 21 and anode side vessel 22, having the hollow flange 20a formed in between the vessels.

Cold cathode side vessel 21 is tubular and large enough in size to house a cold cathode 9 having one opening end with enlarged radius (that is, in the direction of a right angle to the direction of electron beam emission) forming the enlarged radius part 21a. And on the circumference of the enlarged radius part 21a is formed a sealing part 21b circular in shape to be coupled with the anode side vessel 22.

The anode side vessel 22 is also tubular, similar to the cold cathode side vessel 21, and sufficient in size to house an anode 11 having one opening end with enlarged radius (that is, in the direction of a right angle to the direction of electron beam emission) forming the enlarged radius part 22a, and on the circumference of the enlarged radius part 22a is formed a sealing part 22b circular in shape to be coupled with the cathode side vessel 21.

Then, the sealing parts 22a and 22b of the cold cathode side vessel 21 and the anode side vessel 22, respectively, are attached to one another, resulting in the vessel body 20b with both vessels 21 and 22 coupled, which is then sealed and evacuated with cold cathode 9 and anode 11 contained inside. In this way, the vacuum vessel 20, with the flange portion 20a formed in the middle of the vessel body 20a, is obtained.

### Embodiment of Vacuum Vessel

An example is a field emission device with a focusing electrode (grid electrode) shown in FIG. 2A (schematic front view), B (schematic top view), C (schematic bottom view), D (schematic cross section) and E (A-A arrow view). Grid electrode 14 shown in FIG. 2 consists of a flat trunk 14b (disc shape in FIG. 2) sandwiched between the cold cathode side vessel 21 and anode side vessel 22 and a ring shape part 14c, having an open hole 14a sufficient in size for the electron beam to pass through, that fits into the fitting holes on the center of the trunk 14b. The opening area of the open hole 14a is, for example, smaller than the area of the electrode of cold cathode 9 and shelter part of the electron current flow between cold cathode 9 and anode 11.

By having this grid electrode 14, the electron beam is pulled toward anode 11, and the electrons that may be emitted from the circumference of the electrode surface (prone to electric field concentration) of cold cathode 9 are sheltered, resulting in inhibition of deterioration of current and electric discharges. Further, electron current flow is focused and controlled to have a small electronic spot on anode 11. Therefore, the electron current flow between cold cathode 9 and anode 11 is further focused by the grid electrode 14 to make the electronic spot smaller and uniform in distribution, resulting in higher current density. Getter material 15 in FIG. 2 is positioned, for example, on the peripheral side of the open hole 14a on grid electrode 14 (FIG. 2 shows several getters placed at a certain interval in the circumferential direction).

While the grid electrode 14 and the getter material 15 may be positioned in various positions within vacuum vessel 20 as long as they perform their functions, the vessel itself may have to be larger in order to secure sufficient space to have grid electrode 14 and getter 15 if grid electrode 14 and getter 15 are used in the vacuum vessel shown in FIG. 7. On the other hand, it is possible to make use of the hollow part of the flange portion 20 not only for using the flange portion 20 for securing creepage distance and enhanced exothermic efficiency but also for placing grid electrode 14 and getter 15.

For vacuum vessel 20 constructed as above, it is possible to use various materials that are generally used in the field emission device technology, insulating materials such as ceramics (containing, for example, more than 90% alumina) and heat resisting glasses for cold cathode side vessel 21 and anode side vessel 22. For grid electrode 14, alloys (such as Cobar—registered trademark) with a thermal expansion coefficient equivalent to heat resisting glasses or conductive materials such as stainless steel may be used, Cobar may also be used for the ring shape part.

An example of the method to assemble each component material such as cold cathode 9, anode 11, grid electrode 14, cold cathode side vessel 21 and anode side vessel 22 and evacuate to construct vacuum vessel 20 is as follows. Firstly, for cold cathode 9 and anode 11, sealing cap 9a and 11a are pre-brazed with silver alloy to the opening end of the cold cathode side vessel 21 and anode side vessel 22, respectively, as shown in FIG. 2. Next, each fitting surface of sealing cap 9a and 11a and cold cathode side vessel 21 and anode and vessel 22 as well as gripping surface of grid electrode 14, cold cathode side vessel 21 and anode side vessel 22 are activated (at, for example, around 900 C. degrees) by the active metal brazing method (metallization), followed by coupling done by silver alloy brazing to construct a sealed vessel. Then, the sealed vessel is heated to activate the getter material 15 (at, for example, around 800 c-900 c degrees) to absorb residual gaseous molecules within the vessel, and the vacuum vessel 20 with the desired vacuum level is obtained. It is preferable to conduct a deacidification process (for example, treating the material made of tungsten (anode) at 1250 c degrees and the material made of Cobar at 1000 c degrees in advance by electron beam and by vacuum heat treatment furnace for component among those of vacuum vessel 20 that may be hit by electron beam in order to inhibit the degassing phenomenon.

And as shown in FIG. 3A (schematic front view), B (schematic top view), C (schematic bottom view), D (schematic cross section) and E (A-A arrow view), a radiation window 22c (for example, a window made of beryllium or titanium) which X-ray can pass through may be provided on the side wall of anode side vessel 22 (in FIG. 3, on the side wall of sealing cap 11 a elongated in the direction of electron beam emission).

[Example of Cold Cathode]

An example of cold cathode applied to the field emission device under this present invention is disclosed in Patent literature 3. That is the cold cathode with local concentration of electric field, that may occur in the carbon film structures (particularly in the circumference), inhibited due to enlargement of apparent radius of curvature around the carbon film structures by way of placing guard electrode (for example, guard electrode attached to and electrically connected with carbon film structures), which is equipotent with the carbon film structures and/or the substrate, in the circumference of the carbon film structures vis-à-vis carbon film structures form on the substrate surface (for example, formed by plasma CVD method).

The guard electrode that makes apparent radius of curvature around the carbon film structures as referred to above has a convex surface (curved surface in the direction opposite to the direction of film growth) in the direction of the carbon film growth, including that with the curvature radius at the circumference of the guard electrode greater than that on the side of the carbon film structures, and that with the curvature radius being greater as it goes from the carbon film structures side to the guard electrode side or being unchanged (for example, as shown in FIG. 4C, the cross section is quasi-circular).

In more details, as shown in the schematic of FIG. 4A, it includes those that satisfy the relations R1<=R2, where R1 is the curvature radius on the side of carbon film structures 10 and R2 is the curvature radius on the circumference of the guard electrode 10, at the curvature 43a of guard electrode 43 placed on the carbon film structures 10 that are formed thick at the circumference 10a with curvature (In the FIG. 4A, curved with the curvature radius of RO. LO is tangent of the curvature radius RO).

Therefore, various types of guard electrode are applicable as long as they have a convex surface curved in the direction of the carbon film growth, are placed in the circumference of the carbon film structures 10, and make the apparent curvature radius enlarged at the circumference of the carbon film structures 10, not being limited to the shape shown in FIG. 4 as guard electrode 43.

As shown in FIGS. 4A and B, it is desirable not to have gaps between carbon film structures 10 and guard electrode 43, but even if there is a gap 10c after a quasi-ring shape guard electrode 43 is placed as shown in FIG. 4C, as long as that, for example, gap 10c is minute and the tip of curved surface 43a (for example, the peak of cone shape at the circumference) sticks out more than the carbon film structures 10 in the direction of film growth, the equipotential surface is sufficiently flat.

As for the substrate 7, various types of substrate (for example, quasi-circular type, quasi-rectangular Si substrate and SUS substrate, etc.) may be used as long as carbon film structures can be grown on them. For example, in the event that the substrate 7 is a quasi-rectangular one, guard electrode 43 is set on the circumference side of carbon film structures 10 formed on it, so that the apparent radius of curvature around the carbon film structure 10 becomes large.

Furthermore, the surface on which the film grows does not have to be flat and that with concaved surface may do as well. For example, as shown in FIG. 5, the substrate 7 with a concaved surface (the shape with the central part of the electrode surface is curved inward, having radius of curvature) on the side of electrode of cold cathode 9 (the surface on which carbon film structures are formed) may be used. Carbon film structures 10 formed on the concaved substrate 7 have greater curvature toward the circumference against anode 11 when compared to carbon film structures formed on a flat substrate. This means that the electron current band between cold cathode 9 and anode 11 is more focused as it nears the anode 11 and the electron spot on the anode 11 is smaller and more even than the area of electrode surface cold cathode 9, by which a higher current density may be obtained.

Cold cathode 9 may not have to have carbon film structures 10 formed on the entire surface of electrode surface, and that with carbon film structures 10 formed only on part (central part, etc.) of substrate 7 may also be used, in which event it is easier to obtain smaller electron spot and higher current density. An example of the method to form these types of carbon film structures 10 is, as formed (by lithography methods, etc.) as shown in FIG. 6, a combination of electrode side substrate 7a on the electrode side of cold cathode and carbon film structure supporting substrate 7b supporting the electrode side substrate on one end (back side opposite to the electrode side).

While carbon film structure 10 may be used as being simply formed on the substrate 7, it can also be used after having the surface of carbon film structures 10 polished (for example, tip of the circumference 10a is polished). Excessive polishing, however, may reduce the cone shapes of carbon film structures 10 and the characteristics of carbon film structures 10 may be lost significantly.

FIG. 6 shows a portable non-destructive inspection device incorporating X-ray generation device as field emission device related to the secondary invention. This portable non-destructive inspection device 100 consists of the main body 102 that houses X-ray generation device and power supply 103, which are separable, and attachment and separation is done by a mechanical key.

The power supply 103 incorporates transformer 104 and battery case 105, a terminal 106 protrudes from transformer 104, and a handle 107 is attached to the battery case 105 on which a switch 108 is placed.

By making the main body 102 and power supply 103 detachable, each component can be stored separately so that people other than qualified operators may not operate the device. This safety measures may also be achieved by introducing biometrics procedures such as finger print recognition on the switch 108 in order to enhance the security, and the switch may be locked or large current may be applied to destroy the X-ray generation device when unauthorized people attempt to operate it.

Within the main body 102 is housed X-ray generation device 110 enclosed in a stainless steel case. The X-ray generation device consists of emitter unit 120, target unit 130 and coupling unit 140 that couples those two units.

Emitter unit 120 has within it a ceramic vessel 121 containing emitter 122. The top part of emitter 122 reaches the inside of coupling unit 140, and the external surface of vessel 121 is covered by a mold 123 made of silicone or resins such as epoxy. Embedded within the resin mold 123 is lead wire 124 that is connected to a receiving terminal 125.

Target unit 130 has within it a ceramic vessel 131 containing target 132 made of tungsten, etc., and the external surface of the vessel 131 is covered by a mold 131 made of silicone or resins such as epoxy. The back of target 132 exposed from the mold 133 contacts the heat radiation part 134 made of alumina. Embedded within the resin mold 133 is lead wire 135 that is connected to a receiving terminal 136.

Inside the main body 102 positioned adjacent to the heat radiation part 134 is a fan 137 that cools the heat radiation part 134.

Coupling unit 140 is made of metal such as stainless steel and is made cylindrical having an integrated grid electrode 141 near the emitter 122, functioning to focus the electron beam generated by emitter 122 before it hits the target 132.

Getter 142 is placed on one side of the coupling unit 140, and on the side faced with this getter 142 is an exhaust valve 143 used to evacuate inside of the X-ray generation device after emitter unit 120, target unit 130 and coupling unit 140 are coupled and assembled. This exhaust valve 143 is cut and sealed after evacuation.

As shown in FIG. 11, electron generation circuit is placed between emitter 122 and grid electrode 141, and electron acceleration circuit 152 is placed between the grid electrode 141 and target 132. Voltage of (−)40 kV, for example, is applied to emitter and (+)40 kV is applied to target 32, measured from the grid electrode 141.

The electron generation circuit has a detector 153 to measure the current and the current value is sent to the controller 154 to control by feedback the detected current to be within a certain range. The electron acceleration circuit 152 has a detector 155 to measure the voltage and the voltage value is sent to the controller 154 to control by feedback the detected voltage to be within a certain range.

Quantity of X-ray generation (tube voltage) is determined by the applied voltage generated by electron generation circuit 151 controlled at a certain level, and the energy of the X-ray (tube voltage=voltage at the cold cathode+voltage at anode) is determined by the applied voltage by electron acceleration circuit 152.

The emitter 122 consists of substrate 160 made of materials such as stainless steel, carbon film 161 and guard electrode 162 that surrounds the circumference of the substrate 160.

Substrate 160 is long and connected to the cathode side of electron generation circuit 151, having electron emitting surface 163 being the side facing target 132 that is connected to the anode side of electron acceleration circuit 152, and carbon films 161 are formed on the surface of electron emitting surface 163.

The electron emitting surface 163 is placed at a position receding, relative to the direction of electron emission, from the edge of the guard electrode 162. The voltage on the electron emitting surface is reduced in proportion to the rate of the recession, relative to the direction of electron emission, from the edge of the guard electrode 162. Therefore, the strength of the electron beam is controlled by adjusting the recession from the edge of the guard electrode. The electron emitting surface 163 is curved inward and this concave surface has a certain radius of curvature, having a focal point F when parallel incident light hits the surface.

The top of guard electrode 162 is curved outward, and by having the radius of curvature at the outer circumference of this convex (R1) made greater (R1≧R2) than that at the inner circumference of the convex (R2), localized concentration of electric field on the surface of carbon film 161 is inhibited, and current deterioration and electrical discharges caused by heat deterioration are prevented.

When the distance between target 132 and grid electrode 141 is d, and the applied voltage V, then the energy of electric field E is expressed as E=V/d. By having the electron emitting surface 163 receding from the top of the guard electrode 162, the voltage applied to the electron emitting surface 163 is made smaller. The amount of recession is desirable to be 0.5 to 2.0 mm. As a result, in the case of cold cathode, electrons are emitted without direction but they are focused by guard electrode and directed toward the aperture (hole) of the middle electrode. Electrons that pass through the aperture focus on the target.

Carbon film 161 grown on the surface of the electron emitting surface 163 has a thickness of several μm to several tens of μm, has a large number of protrusions distributed over the surface, and each protrusion consists of a bulge formed on the surface of electron emitting surface 163 and needle like form sticking out from the bulge.

FIG. 13 is an example of the structure that destroys the X-ray generation device by running a large current when it is operated by an unauthorized person, and as shown, emitter 122 and guard electrode 162 is separated by insulating material 164 placed in between, with the guard electrode 162 switchable between electron generation circuit 151 and the ground.

When an unauthorized person presses the switch, guard electrode 162 is switched to be connected to the ground. In this event, because emitter 122 and guard electrode 162 are detached, more current runs into guard electrode 162 than into grid electrode 141, inhibiting generation of X-ray. Furthermore, because several tens of KV voltage is applied between target 132 (anode) and grid electrode 141, the current does not reach 132 and discharge current runs into the guard electrode 162 which is closer to grid electrode 141, resulting in destruction of emitter 122.

FIG. 14 is similar to FIG. 6, showing another example of implementation. In this example, target 132 is exposed to the inside of metal connecting member 140 with a window 144 that is covered by a thin beryllium plate 145 to have efficient emission of X-ray through the window by inhibiting attenuation of X-ray.

X-ray generation device 200 shown in FIG. 15 has ceramic vessel 203 that houses emitter 202 and ceramic vessel 205 that houses target metal 204, integrated by connecting member 207 equipped with grid electrode 206.

The emitter 202 is made of conductive material such as stainless steel having a concaved surface with a certain curvature rate, with carbon films formed on its surface with the thickness of several μm to several tens of μm. Emitter 202 made of carbon films emits electrons at a lower temperature compared to a conventional thermal filament.

The target metal 204 is made of tungsten, etc., with a sloped surface where electrons emitted from the emitter 202 hit, and X-ray is generated from the sloped surface when electrons hit it which passes through the window 208 made on the connecting member 207. In order to maintain vacuum within the X-ray generation device 200, the window 208 is sealed tight by a thin film 209 made of beryllium.

Electron generation circuit 210 is placed between the emitter 202 and grid electrode 206, electron acceleration circuit 211 is placed between the grid electrode 206 and target metal 204, and (−)40 kV, for example, is applied to emitter 202, and (+)40 kV is applied to target metal 204, both relative to the grid electrode 204.

As an example of manufacturing ceramic vessels 203 and 205, compact layer 214 is first made, and sponge etc. is set on the compact layer, then the sponge is soaked with ceramic slurry before baking it. The sponge can either be vaporized to make it open cell or the baking stopped half way through. Metallization may be done on the opening edge that is to be attached to the connecting member 207 in order to enhance the air tightness.

As shown in FIG. 17, the connecting member 207 is equipped with an opening 212 which is used for evacuation and a case for getter 213. Getter 213 can be placed on the main body of emitter 202. Ceramic 203 and 20 have identical structure, so the following explanation is on the ceramic vessel 205 that houses target metal 204. Ceramic vessel 205 has a cup shape with one end opening, and the opening end is tightly connected to the connecting member 207 with the closed end supporting target metal 204 and emitter 202 respectively.

Ceramic vessel 205 is made of porous ceramic such as alumina that has three dimensionally continuous pores. The inside surface of this porous ceramic is compact layer 214, and the continuous pores are filled with an insulating oil.

As an example of manufacturing ceramic vessel 205, compact layer 214 is first made, and sponge etc. is set on the compact layer, then the sponge is soaked with ceramic slurry before baking it. The sponge can either be vaporized to make it open cell or the baking stopped half way through. Metallization may be done on the opening edge that is to be attached to the connecting member 207 in order to enhance the air tightness.

Outer surface of ceramic vessel 205 is fitted with metal cover 215, and a gap 216 is formed between the inner surface of metal cover 215 and outer surface of ceramic vessel 205 which serves as a holding pond of insulating oil.

An example of implementation shown in FIG. 15 describes that ceramic vessel 203 that houses emitter 202 and ceramic vessel 205 that house target metal 204 are connected to connecting member 207 with the cup shape opening facing one another. X-ray generation device 300 shown in FIG. 18 and FIG. 19 describes, however, that ceramic vessel 303 that houses emitter 302 and ceramic vessel 305 that houses target metal 304 are connected to connecting member 307 with the cup shape opening facing opposite directions. By this, it is possible to make the length of the X-ray generation device 300 shorter. Further, the X-ray generation device 300 shown in FIG. 18 and FIG. 19 has heat radiating fins 306 on the outer circumference of ceramic vessels 303 and 305.

The above is one example of implementation, and the present invention is not limited to the above. For example, a field emission device related to the primary invention is made to have a space between the flanges when cold cathode side flange portion and anode side flange portion are attached, but it is also acceptable to use a connecting member that has a form of two flanges attached and is placed in between and connected with the cold cathode side vessel and anode side vessel.

### REFERENCE NUMBER LIST

7 . . . substrate, 9 . . . cold cathode, 10 . . . carbon film structures, 11 . . . anode, 14 . . . grid electrode, 15 . . . getter material, 20 . . . vacuum vessel, 20a . . . flange portion, 21 . . . cold cathode side vessel, 22 . . . anode side vessel, 43 . . . guard electrode, 100 . . . non-destructive inspection device, 102 . . . main body, 103 . . . power supply, 104 . . . transformer, 105 . . . battery case, 106 . . . a terminal, 107 . . . handle, 108 . . . switch, 110 . . . X-ray generation device, 120 . . . emitter unit, 130 . . . target unit, 140 . . . coupling unit, 121 . . . vessel, 122 . . . emitter, 123 . . . resin mold, 124 . . . lead wire, 125 . . . receiving terminal, 131 . . . vessel, 132 . . . vessel, 133 . . . resin mold, 134 . . . heat radiating material, 135 . . . lead wire, 136 . . . receiving terminal, 141 . . . grid electrode, 142 . . . getter, 143 . . . exhaust valve, 144 . . . window, 145 . . . beryllium film, 151 . . . electron generation circuit, 152 . . . electron acceleration circuit, 153 . . . detector, 154 . . . controller, 155 . . . detector, 160 . . . substrate, 161 . . . carbon film, 162 . . . guard electrode, 163 . . . electron emitting surface, 164 . . . insulating material, 200 . . . X-ray generation device, 202 . . . emitter, 204 . . . target metal, 203,205 . . . ceramic vessel, 206 . . . grid electrode, 207 . . . connecting member, 208 . . . window, 209 . . . thin film, 210 . . . electron generation circuit, 211 . . . electron acceleration circuit, 212 . . . opening for evacuation, 213 . . . getter, 214 . . . compact layer, 216 . . . gap as a holding pond of insulating oil, 300 . . . X-ray generation device, 302 . . . emitter, 303,305 . . . ceramic vessel, 306 . . . fin, 307 . . . connecting member.

What is claimed is:

1. A field emission device comprising:
a cold cathode made of an electron emitter having a carbon film structures on a surface of a substrate of the electron emitter in a cylindrical vacuum vessel; and
an anode so arranged with its electrode surface as to face the electrode surface of the cold cathode in the cylindrical vacuum vessel; wherein
the cold cathode emits electron beams with field emission by applying a voltage between the cold cathode and the anode, and the vacuum vessel has a hollow flange portion being formed by elongating a part of a side wall of the vacuum vessel located between the cold cathode and the anode in a direction perpendicular to the direction of electron beams emission.

2. The filed emission device according to claim 1, wherein
the vacuum vessel has a cylindrical vessel on the cold cathode side that can house the cold cathode inside and a cylindrical vessel on the anode side that can house the anode inside connected at the flange portion,
the vessel on the cold cathode side has an elongated part on one opening end in the direction of radius and a ring shape sealing part protruding in the direction of coupling with the vessel on the anode side, and
the vessel on the anode side has an elongated part on one opening end in the direction of radius and a ring shape sealing part protruding in the direction of coupling with the vessel on the cold cathode side.

3. The field emission device according to claim 1, further comprising a focusing electrode arranged in the flange portion.

4. A field emission device comprising a cold cathode, a target, and a focusing electrode; wherein
the cold cathode and the target are each housed in a separate vessel, and these vessels are connected by a connecting member having the focusing electrode.

5. The field emission device according to claim 4, wherein the cold cathode and the target are each housed in a ceramic vessel, and the focusing electrode is formed in one into a metal connecting member connected to the ceramic vessel.

6. A Portable non-destructive inspection device having the field emission device according to claim 1 comprising a main body that houses the field emission device and a power supply;
wherein the main body and the power supply are separable.

7. The field emission device according to claim 2, further comprising a focusing electrode arranged in the flange portion.

8. A Portable non-destructive inspection device having the field emission device according to claim 2 comprising a main body that houses the field emission device and a power supply;
wherein the main body and the power supply are separable.

9. A Portable non-destructive inspection device having the field emission device according to claim 3 comprising a main body that houses the field emission device and a power supply;
wherein the main body and the power supply are separable.

10. A Portable non-destructive inspection device having the field emission device according to claim 4 comprising a main body that houses the field emission device and a power supply;
wherein the main body and the power supply are separable.

11. A Portable non-destructive inspection device having the field emission device according to claim 5 comprising a main body that houses the field emission device and a power supply;
wherein the main body and the power supply are separable.

12. A Portable non-destructive inspection device having the field emission device according to claim 6 comprising a main body that houses the field emission device and a power supply;
wherein the main body and the power supply are separable.
